(19) United States
(12) Patent Application Publication
(10) Pub. No.: US 2021/0399285 A1
(43) Pub. Date: Dec. 23, 2021

(54) VANADIUM OXYGEN HYDRATE BASED CATHODES

(71) Applicant: Sparkle Power LLC, Rochester, NY (US)

(72) Inventors: Xing Li, Chengdu (CN); David Mitlin, Hannawa Falls, NY (US); Mingshan Wang, Chengdu (CN)

(21) Appl. No.: 17/347,730

(22) Filed: Jun. 15, 2021

Related U.S. Application Data
(60) Provisional application No. 63/041,533, filed on Jun. 19, 2020.

(51) Int. Cl. H01M 4/36; H01M 10/36; H01M 4/60; H01M 4/58; H01M 4/04; H01M 4/38; H01M 50/44; H01M 50/437

(52) U.S. Cl. CPC H01M 4/364; H01M 10/36; H01M 4/606; H01M 4/5825; H01M 2300/0005; H01M 4/38; H01M 50/44; H01M 50/437; H01M 4/049

(57) ABSTRACT

An electrode for an electrochemical energy storage device having interlayers of vanadium oxygen hydrate (VOH); and polyaniline (PANI) intercalated in the interlayers of VOH. A method for making the same and an electrochemical energy storage device including the aforementioned electrode are also discussed herein.

### CROSS-REFERENCE TO RELATED APPLICATIONS

The instant application is a non-provisional application of, and claims priority to, U.S. Provisional Application No. 63/041,533, filed on Jun. 19, 2020, which is incorporated by reference in its entirety.

### FIELD OF THE INVENTION

The invention is directed to electrochemical energy storage devices, and in particular, an improved electrode for a zinc ion battery.

### BACKGROUND

While lithium ion batteries (LIBs) are showing remarkable growth and market dominance in automotive and portable applications, there is a need for less costly and more safe battery systems based on earth abundant elements. Aqueous secondary batteries based on metal ions including Na⁺, K⁺, Mg²⁺, Zn²⁺, Ca²⁺ and Al²⁺ possess multiple advantages including the natural abundance of potential cathode and anode materials, high fire safety and low system cost, potentially making them suitable for stationary and grid scale energy storage applications.

Aqueous zinc ion batteries (ZIBs) possess a relatively high theoretical energy due to the Zn anode (Zn/Zn²⁺=820 mAh g⁻¹, −0.76 V vs. H₂/H⁺), are safe and inexpensive. Therefore, ZIBs are considered among the most promising aqueous systems and potential alternatives to LIBs. The original ZIBs was the Zn—MnO₂ battery, in 1986. It consisted of a Zn metal anode, a MnO₂ cathode, and a neutral ZnSO₄ aqueous solution as the electrolyte. The cathode material was chosen as α-MnO₂ because of its tunnel structure, which can provide sufficient channels for Zn²⁺ intercalation/extraction. During cycling, however, this structure underwent irreversible phase conversion and manganese dissolution, leading to a dramatic capacity fade. Following these steps, researchers have focused on discovering suitable cathode materials to obtain long-term cyclability in ZIBs. Although ionic radius of Zn²⁺ is relatively small, there are strong electrostatic repulsion forces when intercalating host crystalline structures, resulting in shortcomings in rate kinetics and cyclability. An ideal cathode material would contain a large channel structure to facilitate the reversible intercalation/extraction of Zn²⁺.

Vanadium-based oxides are among the most promising cathode materials for ZIBs due to the polyvalent vanadium ions (+5, +4, +3, +2), which can realize multi-electron transfer with high reversible capacity between 300-400 mAh g⁻¹. Vanadium-based oxides and their derivatives are important compounds used in lithium ion battery and sodium ion battery research, meaning that there a significant body of scientific understanding regarding their structure and synthesis. Current research regarding vanadium-based oxides for ZIBs include vanadium pentoxide (V₂O₅), vanadium oxide (V₆O₁₃), vanadium oxygen hydrate (V₂O₅.nH₂O), vanadate (NaV₃O₈.1.5H₂O, AgVO, ZnVO, etc.) and other derivatives. Among them, V₂O₅ is a typical vanadia-based compound with layered structure. The V atom and the O atom are five-coordinated, forming [VO₅] quadric pyramid and further connecting with each other by common edges. The adjacent layers are connected by van der Waals forces, making it suitable for reversible insertion of Zn²⁺. The earliest V₂O₅ as a ZIB cathode material was put forward by Johnson et al., based on a V₂O₅∥Zn architecture. However, its first discharge specific capacity was limited to 196 mAh g⁻¹, due to the narrow layer spacing of adjacent V—O layers and insufficient Zn²⁺ diffusivity. In turn, expanding the interlayer distance by substituting other metal ions into the structure, such as Zn²⁺, Ca²⁺, Ag⁺, etc. to form Zn_{0.25}V₂O₅.nH₂O, Ca_{0.25}V₂O₅.nH₂O, Ag_{0.4}V₂O₅, is one effective approach for enhancing Zn²⁺ diffusivity.

Another strategy to improve Zn²⁺ diffusion kinetics in V₂O₅ is to pre-intercalate water molecules into the V—O layers to form vanadium oxygen hydrate (VOH). The diffusivity of Zn²⁺ within the more open structure of the hydrate is faster than in anhydrous V₂O₅, leading to improved redox kinetics. However, during the repeated insertion/extraction of Zn²⁺, the intercalated water molecules tend to come out of the interlayers, which ultimately leads to the collapse of the layer structure. Taking advantages of above methods, some researches have combined the approaches, pre-intercalating metal ions into VOH to synergistically increase the stability of layer structure. The results have been hydrated alloy oxides with improved kinetics and stability, including Zn_{0.25}V₂O₅.nH₂O and Ca_{0.25}V₂O₅.nH₂O. In such structures, most the hetero metal ions are redox inactive, which will reduce the overall reversible capacity of the compounds.

### SUMMARY

The present invention is a new approach to boost the kinetics and cyclability of VOH cathodes for aqueous ZIBs. The high-performance cathode material is polyaniline (PANI) intercalated and exfoliated VOH, termed “PANI-VOH”. It was prepared by pre-intercalating an aniline monomer into the interlayers of VOH followed by in-situ polymerization. The relatively simple low-temperature process results in the long chain structure of PANI further exfoliating the VOH into nanosheets that resemble few-layers of graphene. These VOH nanosheets along with PANI provide abundant active sites for reversible Zn²⁺ storage resulting in a substantial reaction-controlled (termed “capacitive”) contribution to the overall capacity. The cycling stability of PANI-VOH is also significantly improved over the VOH baseline.

A new approach is employed to boost the electrochemical kinetics and stability of vanadium oxygen hydrate (VOH, V₂O₅.nH₂O) employed for aqueous zinc ion battery (ZIB) cathodes. The methodology is based on electrically conductive polyaniline (PANI) intercalated-exfoliated VOH, achieved by pre-intercalation of an aniline monomer and its in-situ polymerization within the oxide interlayers. The resulting graphene-like PANI-VOH nanosheets possess a greatly boosted reaction-controlled contribution to the total charge storage capacity, resulting in more material undergoing the reversible V⁵⁺ to V³⁺ redox reaction. The PANI-VOH electrode obtains an impressive capacity of 323 mAh g⁻¹ at 1 A g⁻¹, and state-of-the-art cycling stability at 80% capacity retention after 800 cycles. Because of the facile redox kinetics, the PANI-VOH ZIB obtains uniquely promising specific energies-specific power combinations: An energy of 216 Wh kg⁻¹ is achieved at 252 W kg⁻¹, while 150 Wh kg⁻¹ is achieved at 3900 W kg⁻¹. EIS and GITT analysis indicates that with PANI-VOH nanosheets, there is a simultaneous decrease in the charge transfer resistance and a boost to the diffusion coefficient of Zn²⁺ (by factor of 10-100) versus the VOH baseline. The strategy of employing PANI for combined intercalation-exfoliation may provide a broadly applicable approach for improving the performance in a range of oxide-based energy storage materials.

In one aspect, the invention is directed to an electrode for an electrochemical energy storage device, comprising: interlayers of vanadium oxygen hydrate (VOH); and polyaniline (PANI) intercalated in the interlayers of VOH.

In one embodiment, the electrode is a cathode. In another embodiment, the electrode is an anode. In one embodiment, the electrochemical energy storage device is a zinc ion battery (ZIB), in particular the electrochemical energy storage device is an aqueous ZIB.

Another aspect of the invention is directed to a method of making the above-mentioned electrode, the method comprising: providing VOH, the VOH configured to have interlayers; intercalating aniline monomers into the interlayers of VOH; and after intercalating aniline monomers, in-situ polymerization of the aniline monomers to yield polyaniline intercalated in the interlayers of VOH.

In another aspect, the present invention is directed to a zinc ion battery comprising: an anode; a cathode according to the above-described electrode; a separator; and an electrolyte.

In one embodiment of the ZIB, the anode is a zinc foil. In one embodiment of the ZIB, the separator is selected from a group consisting of glass fiber and filter paper membrane. In one embodiment of the ZIB, the separator is glass fiber. In one embodiment of the ZIB, the electrolyte is selected from the group consisting of Zn salt in additive, 3M zinc trifluoromethylmesylate (Zn(TfO)₂)+6M trifluoromethylsulfimide lithium (LiTFSI), Zinc sulfate-based electrolyte, and KOH-based electrolyte. In one embodiment of the ZIB, the electrolyte is 3M zinc trifluoromethylmesylate (Zn(TfO)₂)+6M trifluoromethylsulfimide lithium (LiTFSI).

While certain embodiments are described and claimed, variations and combinations over the different embodiments are contemplated by the inventors.

### BRIEF DESCRIPTION OF THE FIGURES

The following figures depict certain aspects and embodiments of the invention, but do not limit the invention to what is shown and described in the figures.

FIG. 1 is a Scanning Electron Microscope (SEM) image of PANI-VOH morphology.

FIG. 2 is a front cross section schematic of an electrochemical energy storage device.

FIG. 3 is a schematic of a process according to embodiments described herein.

These and other aspects of the invention are described in more detail herein.

### DETAILED DESCRIPTION

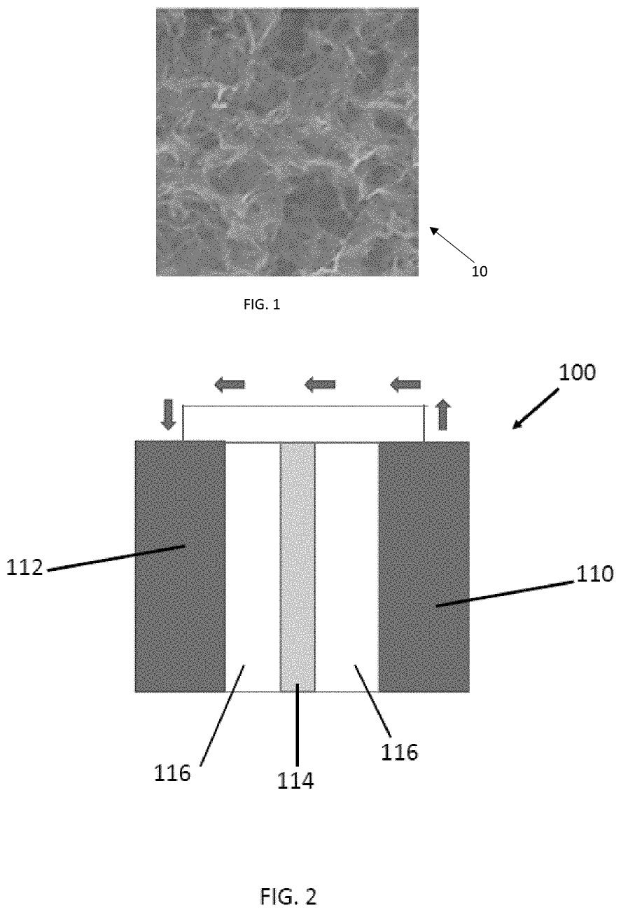

In one aspect, as shown in FIG. 1, the present invention provides a material 10. In one embodiment, the material 10 is electrode for an electrochemical energy storage device 100 (as shown in FIG. 2). The material 10 for the electrode include interlayers of vanadium oxygen hydrate (vanadium oxygen hydrate (VOH, V₂O₅.nH₂O)) (referred to hereinafter as “VOH”). Polyaniline (PANI) is intercalated in the interlayers of VOH.

It is contemplated that the material 10 includes any amount, percentage, or concentration of PANI. In one embodiment, the material 10 includes from 0.1 to 50 wt. % of PANI based on the total weight of material 10. In one embodiment, the material 10 includes from 1.0 to 40 wt. %, 2.0 to 35 wt. %, 5.0 to 25 wt. %, 10 to 20 wt. % of PANI based on the total weight of material 10.

In one embodiment, the electrode is a cathode. In another embodiment, the electrode is an anode. In one embodiment, the electrochemical energy storage device is a zinc ion battery (ZIB), in particular the electrochemical energy storage device is an aqueous ZIB.

In one embodiment, the invention includes an electrochemical energy storage device 100, as shown in FIG. 2. The electrode includes the carbon-based material 10 (not illustrated on FIG. 2). As shown in FIG. 2, the device 100 includes two electrodes: an anode 110 and a cathode 112. In the particular embodiment shown in FIG. 2, the device 100 also includes a separator 114 disposed between the anode 110 and the cathode 112 and an electrolyte 116 in physical contact with both the anode 110 and the cathode 112. In one embodiment, the device 100 is a ZIB. In one embodiment, the device 100 is an aqueous ZIB.

The electrode, i.e., the anode 110 and/or cathode 112, includes the material 10 according to embodiments described herein. It is contemplated that the anode 110 and the cathode 112 may include other material(s) that are readily known and used in anodes and cathodes, e.g., hard carbon, graphite, other carbon-based material, additives, metallic-based materials, support structures, and the like. In one embodiment, the cathode 112 includes the material 10 according to embodiments disclosed herein and the counter electrode, i.e., the anode 110, is zinc foil.

The electrolyte 116 may be organic, ionic liquid, aqueous, or a combination. Standard battery and supercapacitor electrolytes are contemplated. In one embodiment, the electrolyte is Zn salt in additive, 3M zinc trifluoromethylmesylate (Zn(TfO)₂)+6M trifluoromethylsulfimide lithium (LiTFSI), Zinc sulfate-based electrolyte, or a KOH-based electrolyte. Separator 114 may be in accordance with standard battery separators and can include filter membranes or glass fiber.

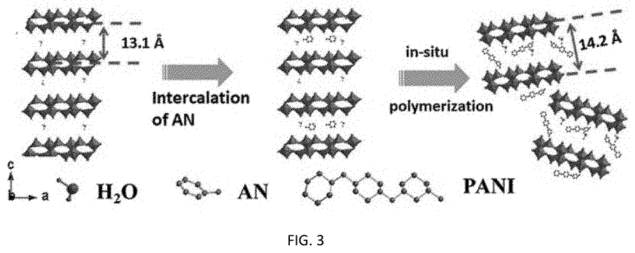

FIG. 3 illustrates a method 200 of making the above-mentioned material 10. The method includes providing interlayers of VOH. Aniline monomers are intercalated into the interlayers of VOH. After intercalating the aniline monomers, in-situ polymerization of the aniline monomers occurs to yield polyaniline intercalated in the interlayers of VOH.

The above embodiments are further discussed in the Examples provided herein.

### EXAMPLES

### I. Synthesis of PANI-VOH

Aniline monomer (AN) (99%) (from Aladin Co. Ltd.), HCl (36.0%-38.0%), H₂O₂ (from Chengdu Kelong Co. Ltd.), and V₂O₅ (99.6%) (from Alpha). All the chemical reagents were directly used without purification. PANI-VOH was synthesis through a low temperature chemical method. Firstly, 2 mmol V₂O₅ was added to 80 mL deionized water with the addition of 2 mL H₂O₂. After stirring for 1 h at room temperature a red solution was obtained. Next, 0.8 mmol AN was added into 150 mL of deionized water. The acidity of AN solution was adjusted using 1M HCl to obtain pH 2. After strong agitation, the V₂O₅ aqueous solution was added into the AN solution and held at 120° C. for 3 h. After that, the precipitate was centrifuged and collected, followed by several iterations of washing with deionized water. Finally, the dark green solids were obtained by freeze drying for 48 h to remove the water. Baseline VOH was synthesized through a comparable approach but without adding AN.

### II. Material Characterization

X-ray diffraction (XRD) analysis was performed using a PANalytical X'Pert Pro diffractometer with Cu Kα radiation (λ=1.5406 Å). Thermogravimetric analysis (TGA) was performed on the Netzsch STA 449F3 analyzer under air, with a ramp rate of 10° C. min⁻¹. Raman spectroscopy analysis was carried out using the Renishaw RM 1000-Invia λ=785 nm with the wavenumber range of 100-2000 cm⁻¹. Fourier-transform infrared (FT-IR) spectra were acquired on a Nicolet 6700 FT-IR Spectrometer. X-ray photoelectron spectroscopy (XPS) analysis was conducted using PHI5000 Versa Probe III with Al Kα radiation. Nitrogen adsorption/desorption isotherms was conducted by the Quadrasorb SI analyzer at 77 K. The morphologies of the samples were characterized by the field-emission scanning electron microscopy FE-SEM (FEI INSPECT-F, 20 kV) and high-resolution transmission electron microscopy HRTEM (Tecnai G2 F20 S-TWIN, 200 kV).

### III. Electrochemical Analysis

Coin cell batteries (2032-type) were assembled in an air atmosphere for electrochemical investigation. PANI-VOH and VOH electrodes were prepared by coating a mixed slurry (active material, acetylene black and PVDF binder with mass ratio of 7:2:1) on titanium foil. The mass loading of the PANI-VOH and VOH cathodes on the current collector was in the 1.8-2.0 mg cm⁻² range. Prior to being placed into the coin cells, the electrodes were dried in a vacuum oven at 70° C. for 12 h. A standard laboratory-grade zinc foil was used as the anode. Glass fibers (GF/A) were used as separators, and a solution of 3M zinc trifluoromethylmesylate (Zn(TfO)₂)+6M trifluoromethylsulfimide lithium (LiTFSI) was utilized as the electrolyte. The 6M LiTFSI is added to Zn(TfO)₂ electrolyte to create a water-in-salt structure. Such electrolyte enables an additional release of zinc ions while depositing Zn²⁺ from solution, improving the overall cell stability including the Coulombic efficiency (CE). At the same time, such a high concentration kinetically suppresses the thermodynamic decomposition of water during cycling. Galvanostatic charge-discharge testing and galvanostatic intermittent titration technique (GITT) analysis was carried using Neware workstation at a current density of 50 mA g⁻¹ and a charge/discharge time and interval of 800 s for each step. Tests were conducted in the voltage range of 0.4-1.6 V, with current densities ranging from 0.3 A g⁻¹ to 5.0 A g⁻¹. CHI760 Shanghai ChenHua workstations were utilized to perform the cyclic voltammogram (CV) testing, using the voltage range of 0.4-1.6 V with scanning rate of 0.1 mV s⁻¹. Electrochemical impedance spectroscopy EIS measurements were conducted in the frequency range of 10⁻²˜10⁵ Hz with the AC amplitude of 5 mV.

XRD results for PANI-VOH and VOH were compared. The diffraction peaks in both materials correspond to the theoretical main diffraction peaks the VOH (PDF No. 25-1006). In baseline VOH, the (002) peak is at 6.66°, corresponding to a layer spacing of 13.1 Å. This indicates that the intercalated water molecules have enlarged the layer spacing from the 10.6 Å for the anhydrous V₂O₅. The (002) peak of PANI-VOH is at 6.24°, with even a larger layer space of 14.2 Å. The existence of PANI in PANI-VOH was confirmed by TG and FTIR analysis. It was found that there is a significant weight loss (8.3%) below 150° C., which correlates to loss of water molecules adsorbed on VOH surfaces, rather than incorporated into the structure. Secondary weight loss of 3% occurs at the temperature range between 150° C. and 350° C., corresponding to the loss of water within the VOH structure. It can be calculated the molar ratio of water in VOH is about 0.3, so that molecular structure of VOH can be considered as V₂O₅.0.3H₂O. Between 150° C. and 350° C. there is a 6.1% weight loss that occurs for PANI-VOH, more than twice that for VOH. This signifies that there is a strong interaction of PANI with the bound water molecules. For PANI-VOH, there is an additional 11.1% weight loss that occurs between 350° C. and 600° C. The thermal loss in this high temperature range is attributed to the thermal decomposition of PANI in air. Therefore, the weight content of PANI in PANI-VOH is calculated to be around 11%.

The FTIR spectra for VOH and PANI-VOH were compared. The main infrared absorption peaks of VOH appear at 3483, 1617, 1014, 765 and 507 cm⁻¹, respectively. The peaks located at 3483 and 1617 cm⁻¹ are indexed to the vibration of hydroxyl in water, coming from the overlap of O—H for structural and absorbed water in VOH. The peak located at 1014 cm⁻¹ is ascribed to the vibration response of V═O in VOH. The two peaks of 765 and 507 cm⁻¹ represent the characteristic absorption peaks of the V—O—V ring. After the introduction of PANI, the characteristic absorption vibration of O—H binding coming from water (3430/1612 cm⁻¹) red shifts about 53/5 cm⁻¹ compared to the absorption peak in VOH. This means that the H—O binding energy of H₂O becomes weaker in PANI-VOH. It demonstrates that there is strong hydrogen bond interaction between H— of H₂O and PANI-VOH, due to the existence PANI. For PANI-VOH, additional absorption vibration peaks appear at 1566, 1467, 1303, 1112 and 1057 cm⁻¹. Among them, 1566 and 1467 cm⁻¹ are the characteristic absorption peaks of quinone (N=Q=N) and benzene (N—B—N) structure from the PANI, respectively. The 1303 and 1112 cm⁻¹ peaks represent the stretching vibration of C—N and the bending vibration of aromatic C—H. The appearance of these peaks directly confirm polymerization of AN within the VOH layers. For PANI-VOH, the V═O peak in VOH at 1014 cm⁻¹ splits into two peaks (995 and 1064 cm⁻¹). This means that there is an interaction between —NH³⁺ of PANI and V═O, giving further evidence for in-situ polymerization.

The Raman spectra of VOH and PANI-VOH were compared. Both spectra show a strong characteristic peak located at 153 cm⁻¹, indexed as the V—O—V chain in the VOH structure. For PANI-VOH, there are characteristic C—H, C—N, and C═C vibration peaks at 1179, 1257/1350, 1564 cm⁻¹, associated with the PANI. The relative intensity of V—O—V peaks in PANI-VOH is weaker than those of VOH. A characteristic peak from V═O appears in 268 cm⁻¹ and blue shifts 3 cm⁻¹ in PANI-VOH. This agrees with the FTIR results, where there is a split in the absorption peak. The Raman spectra show a stretching signal peak at 519 cm⁻¹ and a vibration peak at 695 cm⁻¹, correlated to the V₃—O and V₂—O, respectively. In PANI-VOH, these peaks are relatively weaker than those of in VOH, nominally due to the intercalation of PANI.

The bonding characteristics of VOH and PANI-VOH were further evaluated by XPS.

The V 2p_{1/2} and V 2p_{3/2} spectra of VOH and PANI-VOH were compared. There are two typical peaks in the energy range of 512-527 eV, which are ascribed to the V⁵⁺ and V⁴⁺ species, respectively. This indicates that V⁵⁺ is partly reduced in both VOH and PANI-VOH. However, the peak intensity of V⁴⁺ in PANI-VOH is much higher than VOH, indicating more reduction of V⁵⁺ to V⁴⁺ by the AN. Moreover, the binding energy of V⁵⁺ for PANI-VOH blue shifts 0.3 eV, revealing the change of the electron delocalization for V atoms from V—O layers after the introduction of PANI. From the above results, one can provide a general description for the chemical changes that occur during the synthesis process of PANI-VOH. In this reaction, as shown in FIG. 3, the protonated aniline (aniline-H⁺) along with the water molecules is intercalated in the V₂O₅ interlayers, being attracted to VO₃⁻ by electrostatic assembly. Then, mono aniline-H⁺ in-situ polymerizes to long chain PANI, the process being catalyzed by the V₂O₅. During this process, the V—O interlayers are further expanded and exfoliated.

The PANI-VOH displays significant morphology difference as compared with VOH. It was found that VOH exhibits thick two-dimensional structure. According to the SEM analysis, VOH displays a relatively smooth surface, indicating minimal exfoliation by the water molecules. By contrast, PANI-VOH exhibits a corrugated surface that is full of pores. This is a typical surface morphology that results from gas evolution during an in-situ reaction, likely occurring during the combined intercalation-polymerization process. The N₂ adsorption/desorption curves of PANI-VOH were generated and displayed Type IV isotherms with H4 hysteresis loops. According to the BET tests results shown in Table 1 below, the PANI-VOH possesses a higher S_{BET} than VOH, at 62.45 m² g⁻¹ vs. 2.53 m² g⁻¹, respectively.

TABLE 1

| Samples | S_{BET}(m²g⁻¹) | S_{BJH}(m²g⁻¹) | Vₜₒₜₐₗ(m³g⁻¹) | V_{BJH}(m³g⁻¹) |
|---|---|---|---|---|
| VOH | 2.53 | 3.90 | 0.02 | 0.02 |
| PANI-VOH | 62.45 | 57.84 | 0.63 | 0.64 |

The pore size distribution curve of PANI-VOH indicated a wide size range, from 4-100 nm. The wide pore size distribution is attributed to the stacking of the exfoliated sheets.

Bright field TEM analysis VOH and PANI-VOH was done, further highlighting the differences in their morphology. While VOH is essentially a monolithic particle, the PANI-VOH material is an agglomerate of nanosheets. The HRTEM analysis of PANI-VOH showed its layered structure and gives the thickness of the nanosheets in the assembly. The thickness of the single nanosheet assembly is 13 nm with 5 agglomerated nanosheets being discernable within it. Selected area electron diffraction (SAED) pattern of PANI-VOH taken from the same region as the HRTEM image indicated a highly nanocrystalline structure, with significant peak broadening due to the fine size of the crystallites. Although some lattice structure may be observed in the HRTEM images, the material is effectively diffraction amorphous. TEM energy dispersive X-ray spectroscopy (EDXS) elemental maps of V, O, N and C in of PANI-VOH, confirmed the uniform distribution of PANI at the resolution scale of EDXS analysis. PANI is both on the surface and at the interlayers of VOH. The aniline monomers will diffuse and polymerize at the interlayers of VOH. In parallel the aniline in solution will polymerize and absorb on the VOH surface.

CV curves of PANI-VOH and VOH were taken at cycle 1, tested at 0.1 mVs⁻¹ between 0.4-1.6 V. In baseline VOH, there is one pair of cathodic/anodic, being centered at 0.97/1.1 V. These represent the reduction/oxidation V⁴⁺/V⁵⁺ during intercalation/de-intercalation of Zn²⁺. By contrast, PANI-VOH delivers four redox peaks, these being labeled in the figure. This implies a valence state transition from V⁵⁺ to V⁴⁺/V³⁺ during the multistep intercalation of Zn²⁺. The first redox peak pair is at 0.9/0.99 V and corresponds to V⁵⁺/V⁴⁺. This peak pair exhibits a higher overall peak intensity and less voltage polarization than the VOH baseline, indicating more facile redox kinetics. The other three redox peaks are at 0.76/0.78, 0.62/0.74, and 0.45/0.55 V. The redox pair of 0.76/0.78 V is ascribed to the protonation/deprotonation reaction in the PANI along with the intercalation/de-intercalation of Zn²⁺, both being contributors to the reversible capacity. The remaining two pairs of peaks originate from further redox reaction of V⁵⁺/V⁴⁺ and V⁴⁺/V³⁺. These substantial differences in the CV behavior reveal that that the introduction of PANI facilitates multi-step conversion of V⁵⁺/V⁴⁺/V³⁺ and simultaneously provides additional sites for Zn²⁺ storage.

One and two galvanostatic curves of PANI-VOH were tested at 0.1 A g⁻¹. In both cases, the voltage plateaus are sloping, with a shift to an overall lower voltage during the second discharge. The cycle one and cycle two charge curves are nearly identical. Therefore, it appears that the main irreversible changes to the PANI-VOH structure occurred at cycle one discharge, whereas afterwards the structure remained stable. At cycle one, the electrode delivers discharge/charge capacities of 380/395 mAh g⁻¹, giving a cycle one CE of 96%. The dQ/dV vs. voltage curves reveal finer details of the redox process, not intuitively ascertained from the raw galvanostatic data. These results revealed two redox peak pairs, qualitatively agreeing with the CV results. The baseline VOH displayed a single sloped discharge platform at about 1 V. This plateau is ascribed to the reversible reduction reaction of V⁵⁺. The dQ/dV vs. voltage curves for VOH further verify a single pair of redox peaks. As a result, the VOH only reached a discharge/charge capacity of 247/260 mAh g⁻¹, with a corresponding CE of 93%.

The galvanostatic discharge-charge curves of PANI-VOH show that the sloping plateau is maintained at high charge rates. By contrast, the discharge curves of VOH show a sharp decline without obvious plateaus. The rate performance of PANI-VOH and VOH were compared, with tests performed at currents ranging from 0.3 to 5 A g⁻¹. At all rates, PANI-VOH displays much higher capacities than VOH. For example, PANI-VOH obtains 346, 328, 303, 231, and 186 mAh g⁻¹ at 0.3, 0.5, 1, 3, and 5 A g⁻¹, respectively. For VOH, these values are 190, 185, 168, 136, and 116 mAh g⁻¹ at the same currents. Ragone plots of the Zn∥PANI-VOH battery compare it to state-of-the-art of Zn∥vanadates cathode published in literature. The specific energy and specific power values are obtained from the galvanostatic data, and the calculated values are based on the weight of the active cathode. The Zn∥PANI-VOH battery displayed favorable characteristics, for example 216 Wh kg⁻¹ at 252 W kg⁻¹. Even at very fast charging, the battery still achieved excellent energy, e.g. 150 Wh kg⁻¹ at 3900 W kg⁻¹. Such Ragone characteristics are favorable as compared to other advanced and high performance ZIB cathodes, such as vanadate hydrates (MgₓV₂O₅.nH₂O, Zn₃V₂O₇(OH)₂.2H₂O, CaV₆O₁₆.3H₂O), vanadium oxides (Ag_{0.4}V₂O₅, K₂V₈O₂₁), etc.

Extended cycling performance was tested at 1 A g⁻¹. PANI-VOH exhibited a reversible capacity of 255 mAh g⁻¹ at the first cycle, which increases to 323 mAh g⁻¹ after 6 cycles presumably due to improved wetting by the electrolyte and/or materials utilization. At cycle 800, PANI-VOH had a reversible capacity of 259 mAh g⁻¹, i.e. 80% of the maximum and over 100% of the initial value. Tested at 3 A g⁻¹, PANI-VOH also displayed 223 mAh g⁻¹ after 800 cycles, corresponding to 91% capacity retention. Galvanostatic charge-discharge curves for the two current densities were generated at select cycle numbers. There is good overlap between the galvanostatic curves even after extended cycling, indicating that the PANI-VOH microstructure remains stable. Judging from the extended stability of the PANI-VOH electrode, it does not appear that the structure is degraded to an appreciable extent. If some PANI does diffuse out, it does so only gradually during the 800 cycles, potentially being the source of the minor capacity fade observed. By contrast, after 800 cycles at 1 A g⁻¹, VOH retains 66% of its capacity and delivers 180 mAh g⁻¹. A comparison of cycling stability of PANI-VOH versus the most stable ZIB cathodes is shown in Table 2.

TABLE 2

| | | | Highest | |
|---|---|---|---|---|
| | Current | | capacity | |
| Cathode material | density | | (mAh g⁻¹) | Cycle performance |
| PANI-VOH | 0.1 | A g⁻¹ | 395 | |
| | 1 | A g⁻¹ | 323 | 80%, 800 cycles |
| | 3 | A g⁻¹ | 223 | 91%, 800 cycles |
| Porous V₂O₅ | 0.6 | A g⁻¹ | 166 | 81%, 500 cycles |
| V₂O₅ · nH₂O/graphene | 0.3 | A g⁻¹ | 372 | |
| | 6 | A g⁻¹ | 300 | 71%, 900 cycles |
| V₂O₅@PEDOT/CC | 1 | A g⁻¹ | 312 | 84%, 600 cycles |
| VOH | 1 | A g⁻¹ | 200 | 62.5%, 3000 cycles |
| H₂V₃O₈ | 1 | A g⁻¹ | 327 | 76%, 100 cycles |
| | 5 | A g⁻¹ | 174 | 80%, 1000 cycles |
| LiV₃O₈ | 0.133 | A g⁻¹ | 210 | 75%, 65 cycles |
| K₂V₈O₂₁ | 1 | A g⁻¹ | 282 | 82%, 100 cycles |
| | 6 | A g⁻¹ | 128 | 85%, 300 cycles |
| CuV₂O₆ | 0.2 | A g⁻¹ | 307 | 50%, 150 cycles |
| LiₓV₂O₅ · nH₂O | 1 | A g⁻¹ | 407 | 68%, 50 cycles |
| | 5 | A g⁻¹ | 304 | 76%, 500 cycles |
| Na₂V₆O₁₆ · 1.63H₂O | 0.1 | A g⁻¹ | 296 | 78%, 100 cycles |
| | 1 | A g⁻¹ | 231 | 76%, 500 cycles |
| K₂V₆O₁₆ · 2.7H₂O | 2 | A g⁻¹ | 258 | 76%, 400 cycles |
| CaV₆O₁₆ · 3H₂O | 0.5 | A g⁻¹ | 200 | 75%, 300 cycles |
| Zn₃V₂O₇(OH)₂ · 2H₂O | 0.05 | A g⁻¹ | 213 | |
| | 0.2 | A g⁻¹ | 149 | 68%, 300 cycles |
| Fe₅V₁₅O₃₉(OH)₉ · 9H₂O | 5 | A g⁻¹ | 125 | 80%, 300 cycles |
| VOPO₄ · x H₂O | 2 | A g⁻¹ | 90 | 83%, 500 cycles |
| Na₃V₂(PO₄)₃ | 0.05 | A g⁻¹ | 97 | 74%, 100 cycles |
| VO₂ (B) | 0.1 | A g⁻¹ | 357 | |
| | 2 | A g⁻¹ | 274 | 91%, 300 cycles |
| VS₂ | 0.5 | A g⁻¹ | 145 | 77%, 200 cycles |
| VS₂@VOOH | 2.5 | | 91.4 | 81%, 400 cycles |
| V₃S₄ | 5 | A g⁻¹ | 251 | 40.6%, 1000 cycles |

Systems included in the comparison are V₂O₅, V₂O₅ composites, VOH, H₂V₃O₈, Vanadate (LiV₃O₈, K₂V₈O₂₁, CuV₂O₆), Vanadate hydrate (LiₓV₂O₅.nH₂O, Na₂V₆O₁₆.1.63H₂O, K₂V₆O₁₆.2.7H₂O, CaV₆O₁₆.3H₂O, Zn₃V₂O₇(OH)₂.2H₂O, Fe₅V₁₅O₃₉(OH)₉.9H₂O), VOPO₄.xH₂O, Na₃V₂(PO₄)₃, VO₂(B), VS₂, VS₂@VOOH, V₃S₄. It is observed that PANI-VOH is among the most stable.

The PANI-VOH electro-kinetics were further analyzed through the use of electrochemical impedance spectroscopy (EIS) and galvanostatic intermittent titration technique (GITT) analysis. For both EIS and GITT analysis, the PANI-VOH and the baseline VOH were analyzed after 30 full charge-discharge cycles, performed at 0.1 A g⁻¹. When the PANI-VOH and VOH cells were charged to different voltages (0.4 V, 0.8 V, 1.2 V, and 1.6 V, at 50 mA g⁻¹), the Nyquist plots exhibit a semicircle with an inclined line. The corresponding equivalent circuit fit includes contact resistance between electrolyte and Zn²⁺ (Rₛₒₗ), the migrating resistance of Zn²⁺ ions through the surface layer and the charge transfer resistance (Rₛ+R_{ct}), surface film capacitance (CPE1), double-layer capacitance (CPE2), and the diffusion process of Zn²⁺ within the active electrode corresponding to the Warburg impedance (W). The fitted results are listed in Table 3.

TABLE 3

| Sample | | 0.4 V | 0.8 V | 1.2 V | 1.6 V |
|---|---|---|---|---|---|
| PANI-VOH | Rₑ(Ω) | 4.7 | 1.0 | 2.8 | 2.6 |
| | R [symbol] (Ω) + R [symbol] (Ω) | 55.5 | 25.8 | 22.3 | 5.3 |
| VOH | Rₑ(Ω) | 0.18 | 2.0 | 1.9 | 2.3 |
| | R [symbol] (Ω) + R [symbol] (Ω) | 107.5 | 65.7 | 61.8 | 51.2 |

[symbol]

indicates data missing or illegible when filed

It may be observed that in general, the resistances of PANI-VOH consistently lower that for VOH at every voltage state. For example, in the discharged state of 0.4 V, the Rₛ+R_{ct} of VOH is 107.5Ω, which is twice that of PANI-VOH (55.5Ω). At the charged state of 1.6 V, the Rₛ+R_{ct} of VOH is 51.2Ω, while for PANI-VOH it is 5.3Ω. The EIS results further support the essential role of the PANI in boosting overall electrochemical kinetics of VOH, in this case by decreasing the impedances.

GITT analysis was employed to evaluate the diffusion of Zn²⁺ in the two materials. During the charge/discharge process, PANI-VOH displayed a smaller IR drop at the same pulse and relaxation time. The IR drop detected from the GITT curves are transformed to ion diffusion coefficients D_{Zn}²⁺ and internal reaction resistances RR. Comparing the RR values throughout the entire charge-discharge process, it is apparent that RR for PANI-VOH is consistently half the value for VOH. The calculation details are supplied in Supporting Information, and follow the approach by refs. During the discharge process the Zn²⁺ diffusion coefficients in PANI-VOH range from 5.6×10⁻¹⁶ cm² s⁻¹ at 1.6 V, to 3.6×10⁻¹³ cm² s⁻¹ at 0.4 V. By contrast, for VOH these range from 1.8×10⁻¹⁶ cm² s⁻¹ at 1.6 V, to 4.9×10⁻¹⁴ cm² s⁻¹ at 0.4 V. During the charge process, Zn²⁺ diffusion coefficients in PANI-VOH are 6.8×10⁻¹⁴ cm² s⁻¹ at 0.4 V, and 1.2×10⁻¹³ cm² s⁻¹ at 1.6 V, both values being substantially higher than in VOH under the same conditions. Both systems show a rapid increase in diffusivity at the beginning of discharge (1.6-1.2 V), remaining relatively stable afterward (1.2 and 0.4 V). This agrees with prior reports of higher ionic diffusivity due to deep intercalation of Zn^{2+41,64}. Overall, the Zn²⁺ diffusion coefficient in PANI-VOH is 10 to 100 times higher than in VOH during both charge and discharge. This may be attributed to the role of the PANI and its π-conjugated structure, which reduces the electrostatic interactions between Zn²⁺ and host O²⁻ of V—O layers. A parallel benefit of the PANI, combined with the water molecules between the layers of V₂O₅, is to synergistically stabilize the wide Zn²⁺ diffusion channels. The PANI also boosts the electrical conductivity of the electrode, allowing for sufficient electrical charge transfer to accommodate the rapidly accumulating/depleting Zn²⁺ in the lattice.

To further compare the reaction kinetics of Zn²⁺ in PANI-VOH vs. VOH, CV curves were generated at different scan rates. At scan rates from 0.1 to 0.9 mV s⁻¹, there is a strong redox pair at 0.8/1.1 V. This pair can be evaluated to understand the redox kinetics in terms of being reaction-controlled (activation polarization) or diffusion-controlled (concentration polarization). Although activation polarization is oft taken as “capacitive” contribution, PANI-VOH, VOH and related systems from published literature, the electroactive surface areas are insufficient to generate appreciable current from surface adsorption per se. Rather, what is meant by reaction-controlled in this cases is a kinetically facile bulk process, where solid-state or electrolyte diffusional limitations are secondary. Mathematically, this may be described by following relations, originally obtained for pseudocapacitive oxides. Although the mathematical analysis remains identical regardless of what b=1 is taken to mean, the relatively low surface PANI-VOH and VOH electrodes do not behave like capacitors.

i=av^{b} (Eq. 1)

i(v)=k₁v+k₂v^{1/2} (Eq. 2)

where i refers to the peak current cathodic or anodic currents. The scan rate is v, while a and b are adjustable parameters. The calculated reduction/oxidation b values for PANI-VOH and VOH were 0.78/0.91 and 0.76/0.83, respectively. This indicates that both materials were reaction-controlled, although qualitatively one may argue that PANI-VOH is closer to the ideal b=1. The reaction-controlled proportion for PANI-VOH was 94.9%, which is substantially higher than that for VOH at 80.0%. This difference got even larger at higher scan rates. These results agree the GITT and the rate capability results, and further highlight the facile diffusion kinetics in the PANI-VOH nanosheets.

To understand the Zn²⁺ storage mechanisms, post-mortem XRD analysis was performed on PANI-VOH at different charge/discharge voltages. When battery discharge from the initial 1.37 to 0.9 V, the (002) peak at 6.5° for PANI-VOH becomes wider with its center shifting to a smaller angle. This may be understood in terms of the expansion of V—O layers due to Zn²⁺ intercalation. This process corresponds to the reduction of V⁵⁺ to V⁴⁺ and the formation of Zn_{0.3}V₂O₅.nH₂O. When further discharged to 0.4 V, the peak from Zn_{0.3}V₂O₅.nH₂O gradually decreases in intensity. Meanwhile a sharp peak initiates at 5.8°, and may be ascribed to the formation of ZnₓV₂O₅₋ₓ.nH₂O (0.3<x<1.4), corresponding to further reduction of V⁴⁺ to V³⁺. This directly confirms that a multivalent reduction process is active in PANI-VOH. Additionally, a new peak located at 12°, which is related to the formation of Zn₃(OH)₂V₂O₇.2H₂O (PDF No. 87-0417). The formation of Zn₃(OH)₂V₂O₇.2H₂O is ascribed to the enhanced interaction between Zn²⁺ and vanadium-oxygen layers accompanied by the reactions with water molecules in the aqueous electrolyte. Another new peak near 18° may be ascribed to the formation of Znₓ(OTf)_{y}(OH)_{2x-y}.nH₂O, per prior reports Znₓ(OTf)_{y}(OH)_{2x-y}.nH₂O may form due to the reaction of Zn²⁺ with OTf⁺ and water, on the surface of electrode. After being fully charged, the 8° and 12° peaks disappeared. When the electrode is discharged to 0.4 V, the peaks at 5.8° and 12° are again prominent. This illustrates the reversibility of the transformation process.

Post-mortem HRTEM analysis of PANI-VOH after discharge to 0.4 V, showed a prominent ring in the associated selected area electron diffraction (SAED) pattern corresponded to a lattice spacing of 0.231 nm and is indexed as the (510) plane of VOH (PDF No. 25-1006). The expansion of VOH crystal structure arises from Zn²⁺ intercalation, agreeing with the XRD results. When fully charged, the PANI-VOH remained nanocrystalline. One set of lattice plane spacings is measured to be 0.20 nm, which are the (510) planes of VOH. In the SAED pattern, the two additional indexed planes of VOH are (510) and (−518). Examining the HRTEM results of as-synthesized vs. the post discharge/charge PANI-VOH, it is concluded that the deep Zn²⁺ intercalation process causes a crystallite size refinement. This is expected to boost the electrochemical kinetics. The substantial changes in the structure would also explain the differences between the shapes of the first and the second galvanostatic curves.

Post-mortem XPS analysis was also applied to the PANI-VOH and VOH specimens at different states of charge. When discharged to 0.4 V, PANI-VOH displayed strong peaks associated with both V⁴⁺ (516.8 eV) and V³⁺ (515.4 eV), in comparison to VOH where these peaks are less prominent. In parallel, for PANI-VOH the peak intensity associated with V⁵⁺ (517.8 eV) is sharply decreased. However, V³⁺ was barely detected in the VOH when discharge to 0.4 V. Rather, the VOH still maintains the V⁵⁺ peak (516.7 eV) after discharge to 0.4 V. When charged to 1.6 V, PANI-VOH reverts approximately the same intensity for V⁴⁺ as the as-synthesized sample analyzed by XPS. By contrast, there is little V⁴⁺ that remains in VOH when charged back 1.6 V, indicating some level of structural disintegration from the onset. Therefore, it may be concluded that the higher reversible reduction capability of vanadium ions in PANI-VOH directly accounts for its higher reversible capacity. For N1s of the PANI in PANI-VOH, there are three peaks at 400.8, 399.2, and 398.3 eV, corresponding to the binding energies of —N⁺═, —N—, and —N═ at full discharge state, respectively. When battery charges from 0.4 V to 1.6 V, the binding energy of —N— gradually transforms to —N⁺═ and —N═. This verifies that PANI is involved in the electrochemical reaction through a doping/de-doping reaction.

During the initial discharge process, Zn²⁺ ions intercalate into the oxide and further expand the layered structure. Then, two new phases of ZnₓV₂O₅₋ₓ.nH₂O (0.3<x<1.4) and Zn₃(OH)₂V₂O₇.2H₂O are formed, both being nanocrystalline. This process is aided by the exfoliated nanosheet morphology of PANI-VOH, which reduces the solid-state diffusion distances. Meanwhile, the incorporation of PANI increases the ion solid-state diffusivity by one to two orders of magnitude, both during charge and during discharge. During the charge process, Zn²⁺ ions are de-intercalated from ZnₓV₂O₅₋ₓ.nH₂O (0.3<x<1.4) and Zn₃(OH)₂V₂O₇.2H₂O nanostructures. In the process, these phases transform back to the parent VOH structure but with a refined nanocrystalline size as well. During the subsequent charging-discharging cycling, these nanocrystalline structures remain stable, as indirectly inferred from the close overlap of the galvanostatic and CV curves after the second discharge.

Vanadium oxygen hydrate (VOH) cathodes for aqueous zinc ion batteries (ZIBs) are limited in performance due the kinetic difficulty of reversibly intercalating Zn²⁺ into their bulk structure. In this work, a new approach is employed to facilitate surface charge transfer at VOH interlayers and thereby obtain improved Zn²⁺ storage kinetics and cyclability. Polyaniline (PANI) intercalated-exfoliated VOH (termed PANI-VOH) is synthesized through pre-intercalation of an aniline monomer and its in-situ polymerization within the interlayers. The resulting graphene-like VOH nanosheets possess one to two order of magnitude improved solid-state diffusivity, leading to significantly faster charging-discharging kinetics, allowing the material to undergo the full V⁵⁺ to V³⁺ redox reaction. In parallel, the intercalated PANI promotes enhanced structural stability of the VOH during cycling. The multi-electron transform ability in PANI-VOH is ascribed to the unique π-conjugated structure of PANI. It effectively alleviates electrostatic interactions between Zn²⁺ and host O²⁻ of V—O layers, increasing the solid-state ion diffusivity by more than an order of magnitude. The PANI also stabilizes the ion diffusion channels in the oxide, while improving the ion charge transfer kinetics and electrical conductivity of the electrode.

As will be apparent to those skilled in the art, various modifications, adaptations and variations of the foregoing specific disclosure can be made without departing from the scope of the invention claimed herein. The various features and elements of the invention described herein may be combined in a manner different than the specific examples described or claimed herein without departing from the scope of the invention. In other words, any element or feature may be combined with any other element or feature in different embodiments, unless there is an obvious or inherent incompatibility between the two, or it is specifically excluded.

References in the specification to “one embodiment,” “an embodiment,” etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such aspect, feature, structure, or characteristic with other embodiments, whether or not explicitly described.

The singular forms “a,” “an,” and “the” include plural reference unless the context clearly dictates otherwise. Thus, for example, a reference to “a plant” includes a plurality of such plants. It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The term “and/or” means any one of the items, any combination of the items, or all of the items with which this term is associated. The phrase “one or more” is readily understood by one of skill in the art, particularly when read in context of its usage.

Each numerical or measured value in this specification is modified by the term “about”. The term “about” can refer to a variation of ±5%, ±10%, ±20%, or ±25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by the skilled artisan, all numbers, including those expressing quantities of reagents or ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range (e.g., weight percents or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, as used in an explicit negative limitation.

What is claimed is:

1. An electrode for an electrochemical energy storage device, comprising:
interlayers of vanadium oxygen hydrate (VOH); and
polyaniline (PANI) intercalated in the interlayers of VOH.

2. The electrode according to claim 1, wherein the electrode is a cathode.

3. The electrode according to claim 2, wherein the electrochemical energy storage device is a zinc ion battery (ZIB).

4. The electrode according to claim 3, wherein the ZIB is an aqueous ZIB.

5. The electrode according to claim 1, wherein the electrode is an anode.

6. The electrode according to claim 1, comprising a capacity of 323 mAh g⁻¹ at 1 A g⁻¹, and cycling stability at 80% capacity retention after 800 cycles.

7. A method of making an electrode according to claim 1, the method comprising:
providing VOH, the VOH configured to have interlayers;
intercalating aniline monomers into the interlayers of VOH; and
after intercalating aniline monomers, in-situ polymerization of the aniline monomers to yield polyaniline intercalated in the interlayers of VOH.

8. A zinc ion battery (ZIB) comprising:
an anode;
a cathode according to claim 1;
a separator; and
an electrolyte.

9. The ZIB according to claim 8, wherein the anode is a zinc foil.

10. The ZIB according to claim 8, wherein the separator is selected from a group consisting of glass fiber and filter paper membrane.

11. The ZIB according to claim 10, wherein the separator is glass fiber.

12. The ZIB according to claim 8, wherein the electrolyte is selected from the group consisting of Zn salt in additive, 3M zinc trifluoromethylmesylate (Zn(TfO)₂)+6M trifluoromethylsulfimide lithium (LiTFSI), Zinc sulfate-based electrolyte, and KOH-based electrolyte.

13. The ZIB according to claim 12, wherein the electrolyte is 3M zinc trifluoromethylmesylate (Zn(TfO)₂)+6M trifluoromethylsulfimide lithium (LiTFSI).
